(19) United States
(12) Patent Application Publication
(10) Pub. No.: US 2024/0137347 A1
(43) Pub. Date: Apr. 25, 2024

(54) PRIVACY-ENHANCED SENSOR DATA EXCHANGE SYSTEM

(71) Applicant: Intel Corporation, Santa Clara, CA (US)

(72) Inventor: Robert Vaughn, Portland, OR (US)

(21) Appl. No.: 18/400,770

(22) Filed: Dec. 29, 2023

(51) Int. Cl. H04L 9/40; G06F 21/60

(52) U.S. Cl. CPC H04L 63/0428; G06F 21/604

(57) ABSTRACT

A system for privacy-enhanced sensor data exchange, including: a communication interface operable to receive sensor data related to surroundings of a sensor associated with an ego device; processor circuitry operable to: evaluate the sensor data for a privacy-sensitive attribute of the sensor data, wherein the sensor data is under privacy control of the ego device; filter the sensor data by decreasing a precision of a portion of the sensor data related to the privacy-sensitive attribute; and generate data packets based on the sensor data, formatted to enable discovery by an interested entity device.

### TECHNICAL FIELD

Aspects described herein relate in general to privacy-enhanced exchange of sensor data, and in particular to privacy-enhanced exchange of sensor data that remains searchable by interested parties.

### BACKGROUND

Many vehicles are equipped with cameras that capture video, audio, and other sensor-derived data. In specific instances, a vehicle in close proximity might record video, for example, of a vehicular accident, which could prove valuable to another vehicle's driver. However, existing methods for obtaining access to such video recordings frequently violate the privacy rights of the involved drivers.

### BRIEF DESCRIPTION OF THE FIGURES

FIG. 1 illustrates a flowchart of a system for privacy-enhanced sensor data exchange in accordance with aspects of the disclosure.

FIG. 2 illustrates a flowchart of a system for privacy-enhanced sensor data exchange in accordance with aspects of the disclosure.

FIGS. 3A and 3B illustrate examples of data packets in accordance with aspects of the disclosure.

FIG. 4 illustrates a block diagram of a computing device, in accordance with aspects of the disclosure.

### DETAILED DESCRIPTION

This disclosure relates to a system for providing authorized access to sensor data (e.g., a video recording) originating from an ego device (e.g., a vehicle). A secure communication channel preserves the privacy of both an entity requesting the sensor data and a vehicle owner while ensuring verification of the authenticity of the sensor data. The system may obscure privacy-sensitive attributes such as the identity of the vehicle, the association between the vehicle and the owner, timestamped location details of the vehicle, and the email addresses of both the vehicle owner and the entity requesting the sensor data. While it is known to use an intermediary, such as a third-party data broker, to assist in the identification and distribution of sensor data, in this system, the third party-broker does not have access to or awareness of identity information of participants.

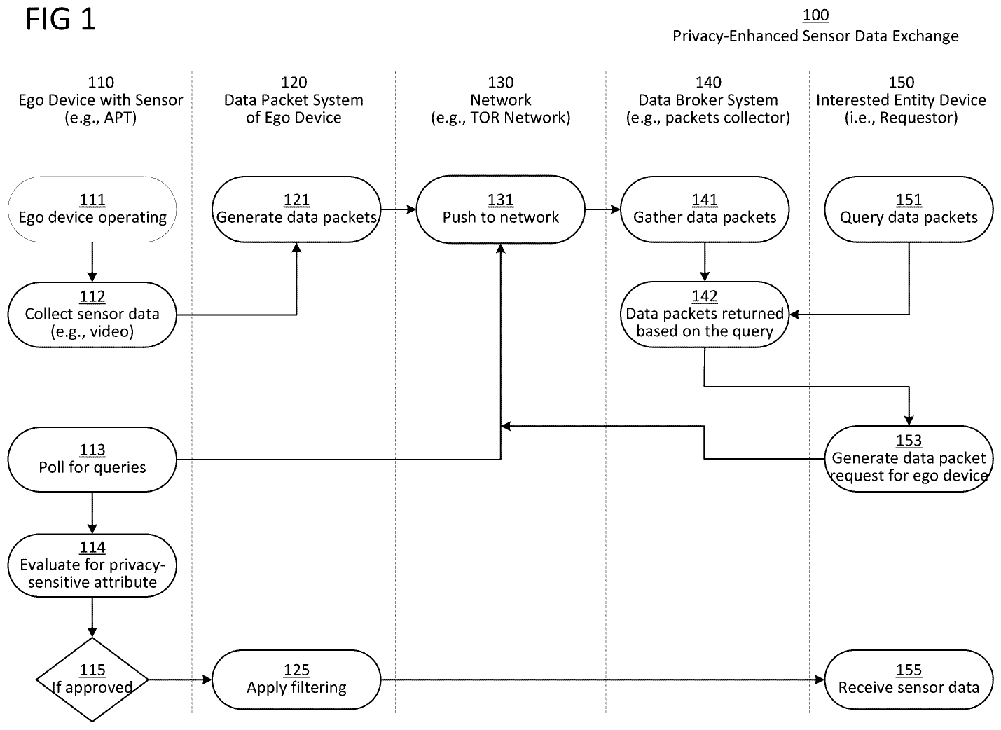

FIG. 1 illustrates a flowchart of a system for privacy-enhanced sensor data exchange 100 in accordance with aspects of the disclosure.

The system for privacy-enhanced sensor data exchange 100 generally comprises an ego device 110, a data packet system 120 of the ego device 110, a network 130, a data broker system 140, and an interested entity device 150 (i.e., requestor).

The ego device 110 serves as the primary entity. The ego device 110 may be, an autonomous entity (e.g., vehicle, drone, robot), a manually operated vehicle, a wireless communication device, a smartphone, a video recording device, an aircraft, or any other device capable of collecting sensor data.

The data packet system 120, which may be integrated into the ego device 110 or be separate, manages data packet processing. The network 130 may be a TOR (The Onion Router) network or other privacy-enabling network that facilitates secure data transmission. The data broker system 140 is operable to negotiate the exchange of sensor data between the ego device 110 and the interested entity 150. The interested entity device 150 represents a sensor data requestor or sensor data recipient. There may be more than one interested entity device 150.

Collection of Sensor Data

In steps 111 and 112, the ego device 110 is operating and collecting sensor data related to the environment of a sensor associated with that ego device 110. This sensor data may include, for example, video recordings and any associated information. The sensor data may be immediately used and discarded, stored within the ego device 110 for later access, and/or streamed in real-time to a vehicle-to-everything (V2X) network.

The ego device 110 analyzes the sensor data to identify any attributes of the sensor data that are privacy sensitive. This sensor data remains under the privacy control of the ego device 110. The identification of privacy-sensitive attributes may be based on temporal aspects of the sensor data. In some instances, these attributes may be determined based on a geographic aspect associated with the sensor data.

In step 121, the data packet system 120 generates data packets based on the sensor data. The data packet system 120 may be operable to encrypt a portion of the sensor data to be not discoverable by the interested entity device 150 or a data broker system 140. Additionally, the data packet system 120 may be operable to generate false data packets, synthetic data packets, or modified data packets to obfuscate the privacy-sensitive attribute of the sensor data. In general, the format of these data packets is designed to enable their discovery by an interested entity device 150.

Further, the data packet system 120 may be operable to mask privacy-sensitive elements within the sensor data. The initially captured and stored sensor data is in its unprocessed, raw form. Should this raw data be retained within the storage system of the ego device 110, the creation of a masked video would constitute a derivative recording. Various methods can be used to achieve this anonymization of the sensor data. One such method is to retain the raw video while incorporating meta tags to identify and overlay specific portions of the footage, such as license plates. Alternatively, an anonymization mask could be applied directly to an already processed video, effectively obscuring the sensitive information.

In step 131, the data packet system 120 pushes the data packets into the network 130. The network 130 may be a multi-layered encryption system such as an onion network (TOR network) designed for anonymity, a communication system operable to encrypt data in layers to maintain anonymity, or it may include transmission to a cloud-based storage or a data broker system 140 (step 141). The data broker system 140 does not have access to fully decrypted sensor data from the ego device 110. The ego device 110 might also transmit the data packets to the interested entity device 150 directly, as described below.

Sensor Data Discovery

In scenarios where the interested entity device 150 seeks to access the sensor data (e.g., video recordings collected by the ego device 110), the interested entity device 150 initiates a query process via the data broker system 140 by generating a data packet query at step 151. During query generation, the interested entity device 150 may be presented with multiple search fields including date/time range, geographic coordinates (GPS range), and the specific type of sensor data.

Subsequently, the data broker system 140 processes the query at step 142, identifying and returning data packets that match the specified criteria and fall within the defined search ranges. The returned search results may be characterized in binary format (yes/no) indicating the presence of relevant sensor data, along with a quantification of the resulting data packets. After reviewing these initial search results, the interested entity device 150 proceeds to step 153, wherein a request for data packets may be formulated. This request directed to device 110 based on the initial search results and includes a request to view or acquire the identified data packets.

The data broker system 140 then posts a notification to a portal accessible to the interested entity device 150. This notification includes the hash of a data packet and a unique random token. Optionally, the notification may include payment details relevant to the acquisition of the data packet, as may be configured by the data broker system 140.

Communication Between Interested Entity Device 150 and Ego Device 110

At step 113, the ego device 110 initiates a polling of the data broker system 140. This action is in anticipation of a sensor data request (step 153) from the interested entity device 150. The ego device 110 retains the discretion to ignore any requests. However, if the ego device 110 chooses to engage, the ego device 110 may transmit a data packet to the data broker system 140. The ego device 110 uses a retained secret seed to generate a hash of a random token combined with their “seed2.” The data broker system 140, which is privy to both “seed2” and the random token, uses this information to authenticate the interested entity device 150. This authentication paves the way for the data broker system 140 to facilitate an exchange of sensor data between the ego device 110 and the interested entity device 150. Thereafter, the ego device 110 and interested entity device 150 may either establish a direct communication channel or continue to work through the data broker system 140.

Moving to step 114, the ego device 110 evaluates the sensor data and/or the sensor data request (step 153). This evaluation focuses on identifying any privacy-sensitive attributes within the sensor data that remain under the privacy control of the ego device 110.

At step 115, after approving the sensor data request (step 153), the ego device 110 pushes the data packets to the interested entity device 150. This push may occur directly between the ego device 110 and the interested entity device 150, bypassing the data broker system 140.

At step 125, prior to pushing the data packets, the data packet system 120 can filter the sensor data. This filtering specifically targets the privacy-sensitive attributes of the sensor data. The goal is to reduce the accuracy of the data associated with the attributes, thereby increasing the privacy and security of the transmitted information.

Noise Enhanced Obfuscation

In certain embodiments, the ego device 110 may employ methods to obscure personally identifiable information present in the sensor data. This may include, but is not limited to, anonymizing unique identifiers such as license plates or obfuscating entire vehicles in the captured data.

The sensor data captured by the ego device 110 may either be retained locally within the ego device 110 or transferred to an external data storage entity. One aspect of introducing noise into the data for privacy protection is to control the noise generation process. This process should be managed in a manner that ensures the indistinguishability of authentic sensor data from the inserted noise. By designing the data packet system 120 to autonomously generate this noise, the confidentiality of the actual sensor data may be maintained. As a result, when sensor data is queried, multiple sets of data packets are returned in which both authentic sensor data and noise are indistinguishable. The distinction between actual sensor data and noise is not clarified until the ego device 110 authorizes the sharing of specific sensor data.

The ego device 110 is the preferred device for noise generation. This approach ensures that the data broker system 140 and other entities are unable to distinguish between noise and actual sensor data. However, in another aspect, the data broker system 140 could also introduce noise into the sensor data as an additional or alternative means of obfuscation.

Verification

In step 155, the interested entity device 150 processes the received sensor data to verify its authenticity. This is accomplished by performing a hash function on the sensor data and then comparing the resulting hash value to the one originally provided by the ego device 110. This comparison serves to confirm that the sensor data has remained unchanged and authentic during transmission.

Escrow Service

The ego device 110 may be configured to enable a transactional framework in which it receives compensation in exchange for transmitting data packets to the interested entity device 150. As an illustrative scenario, the ego device 110 captures and transmits video footage of a vehicle accident and subsequent events, which has value to certain entities. This model extends to various monetizable use cases, such as inspecting of road conditions, monitoring traffic in near real-time, and providing remote viewing capabilities for entertainment purposes.

Restricting Sensor Data Access

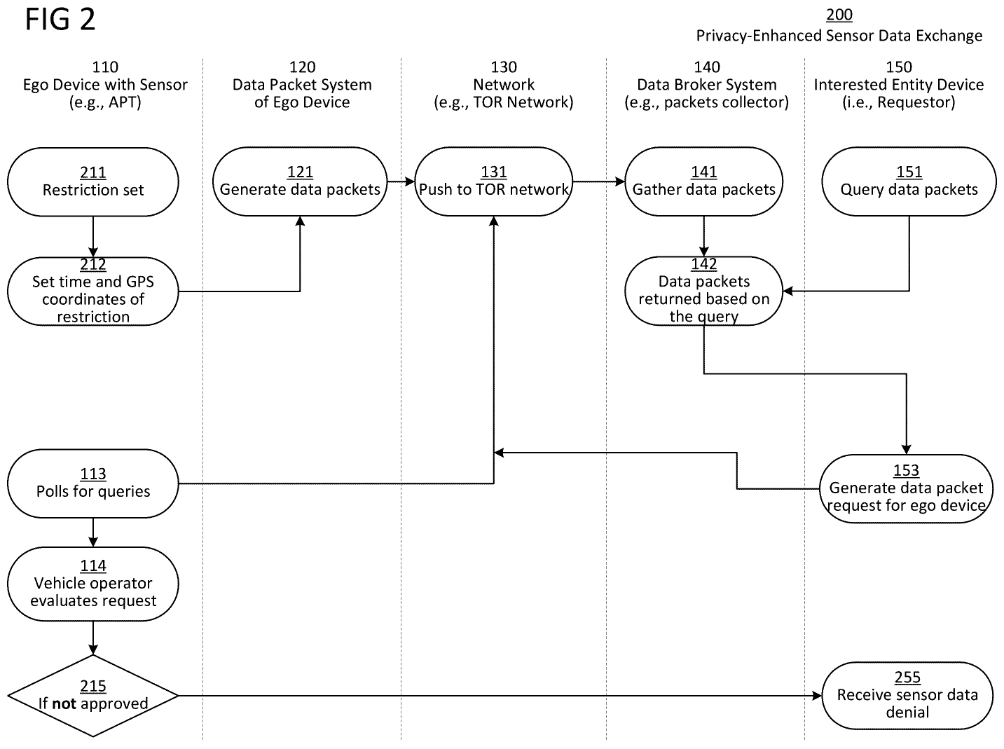

FIG. 2 illustrates a flowchart of a privacy-enhanced sensor data exchange system 200 in accordance with aspects of the disclosure.

This privacy-enhanced sensor data exchange system 200, while similar to the system 100 of FIG. 1, alters the process by authorizing a restricting entity device to implement geo-fencing based on location and/or time constraints (steps 211 and 212). Specifically, a restricting entity device is authorized to restrict from discovery or access by the interested entity device 150 of portions of the sensor data associated with a predefined geo graphic region or a defined temporal period. This restricting entity device may provide credentials or authority for such restriction (e.g., an authorized agency or individual). The ego device 110 may interpret and evaluate the request in an automated manner according to predefined rules and parameters. Depending on the scenario, the restricting entity device may initiate a geo-fencing protocol either directly from a vehicle or device, thereby linking the restriction geographically and temporally, or alternatively from a non-autonomous device such as a mobile phone, which establishes a geographic and temporal link but includes identifiable information of the restricting entity device for enhanced accountability. If the ego device 110 denies a request for sensor data at step 215, it issues a sensor data access denial notification 255 to the interested entity device 150.

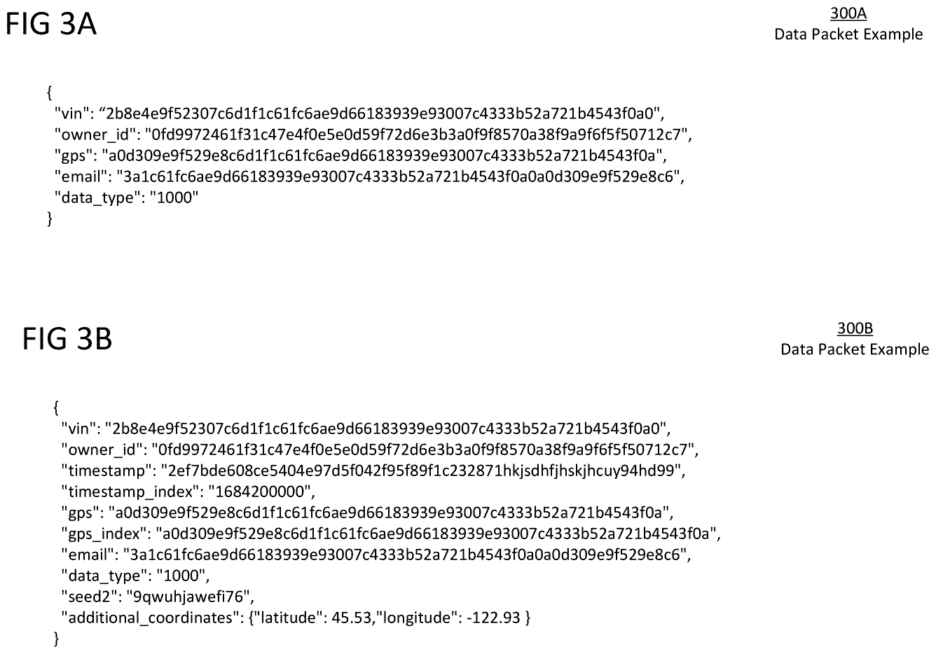

FIGS. 3A and 3B illustrate examples of data packets 300 (300A and 300B) in accordance with aspects of the disclosure.

The data packets 300 have seed hashed personally identifiable information (PII) such as vehicle identification number (VIN), owner identification (owner_id), GPS coordinates, and email addresses. The data type (data_type) is a plain text value or a reserved keyword/string, for example, describing JPEG high-resolution video. Alternative methods to seed hashing are applicable for data protection.

These data packets 300 are designed to be shared with the data broker system 140, keeping personally identifiable information (PII) private. However, if GPS coordinates are seed hashed without revealing the seed, their discovery becomes impossible. Conversely, if GPS coordinates are stored in raw high resolution (e.g., {“latitude”: 45.5320, “longitude”: −122.9344}), then an interested entity device 150 (requestor) may attract entities (requestors) seeking specific location data, rendering location-based video requests impractical.

Consumer GPS devices or mapping services provide coordinates with a resolution of several meters to tens of meters. Therefore, the system 100 should store GPS data at a lower resolution by reducing the number of decimal places, e.g., {“latitude”: 45.53, “longitude”: −122.93}.

Similarly, for timestamps in data packet 300B, the granularity of the timestamp (i.e., “timestamp”: “2ef7bde608ce5404e97d5f042f95f89f1c232871hkjsdhfjhskjhcuy94hd99”) is reduced in the timestamp index field (i.e., “timestamp_index”: “1684200000”).

The data packets 300 reveal GPS coordinate leakage. To mitigate privacy violations, an entropy value is calculated by the ego device 110. The ego device 110 evaluates a number of nearby vehicles over time. If there are not enough vehicles to ensure privacy, the ego device 110 may decide not to share sensor data. The privacy threshold is adjustable by the ego device 110.

To represent entropy in a time-varying sensor data set, the ego device 110 may use a formula that considers outcome probabilities or frequencies. One option is the Shannon entropy formula. The sensor data packet could then be transmitted to the data broker system 140, with the seed in the ego device 110. The ego device 110 also retains a hash of the data packet.

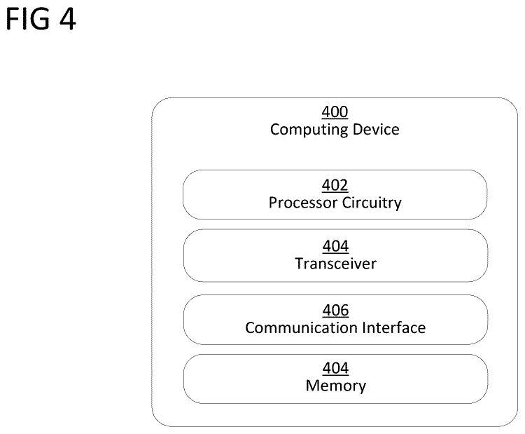

FIG. 4 illustrates a block diagram of a computing device 400 in accordance with aspects of the disclosure. The computing device 400 may be identified with a central controller and be implemented as any suitable network infrastructure component, which may be implemented as a cloud/edge network server, controller, computing device, etc. The computing device 400 may serve the system 100, 200 for privacy-enhanced data exchange in accordance with the various techniques as discussed herein. To do so, the computing device 400 may include processor circuitry 402, a transceiver 404, communication interface 406, and a memory 408. The components shown in FIG. 4 are provided for ease of explanation, and the computing device 400 may implement additional, less, or alternative components as those shown in FIG. 4.

The processor circuitry 402 may be operable as any suitable number and/or type of computer processors, which may function to control the computing device 400. The processor circuitry 402 may be identified with one or more processors (or suitable portions thereof) implemented by the computing device 400. The processor circuitry 402 may be identified with one or more processors such as a host processor, a digital signal processor, one or more microprocessors, graphics processors, baseband processors, microcontrollers, an application-specific integrated circuit (ASIC), part (or the entirety of) a field-programmable gate array (FPGA), etc.

In any event, the processor circuitry 402 may be operable to carry out instructions to perform arithmetical, logical, and/or input/output (I/O) operations, and/or to control the operation of one or more components of computing device 400 to perform various functions as described herein. The processor circuitry 402 may include one or more microprocessor cores, memory registers, buffers, clocks, etc., and may generate electronic control signals associated with the components of the computing device 400 to control and/or modify the operation of these components. The processor circuitry 402 may communicate with and/or control functions associated with the transceiver 404, the communication interface 406, and/or the memory 408. The processor circuitry 402 may additionally perform various operations to control the communications, communications scheduling, and/or operation of other network infrastructure components that are communicatively coupled to the computing device 400.

The transceiver 404 may be implemented as any suitable number and/or type of components operable to transmit and/or receive data packets and/or wireless signals in accordance with any suitable number and/or type of communication protocols. The transceiver 404 may include any suitable type of components to facilitate this functionality, including components associated with known transceiver, transmitter, and/or receiver operation, configurations, and implementations. Although depicted in FIG. 4 as a transceiver, the transceiver 404 may include any suitable number of transmitters, receivers, or combinations of these that may be integrated into a single transceiver or as multiple transceivers or transceiver modules. The transceiver 404 may include components typically identified with a radio frequency (RF) front end and include, for example, antennas, ports, power amplifiers (PAs), RF filters, mixers, local oscillators (LOs), low noise amplifiers (LNAs), up-converters, down-converters, channel tuners, etc.

The communication interface 406 may be operable as any suitable number and/or type of components operable to facilitate the transceiver 404 receiving and/or transmitting data and/or signals in accordance with one or more communication protocols, as discussed herein. The communication interface 406 may be implemented as any suitable number and/or type of components that function to interface with the transceiver 404, such as analog-to-digital converters (ADCs), digital to analog converters, intermediate frequency (IF) amplifiers and/or filters, modulators, demodulators, baseband processors, etc. The communication interface 406 may thus work in conjunction with the transceiver 404 and form part of an overall communication circuitry implemented by the computing device 400, which may be implemented via the computing device 400 to transmit commands and/or control signals to execute any of the functions describe herein.

The memory 408 (non-transitory computer-readable storage medium) is operable to store data and/or instructions such that, when the instructions are executed by the processor circuitry 402, cause the computing device 400 to perform various functions as described herein. The memory 408 may be implemented as any well-known volatile and/or non-volatile memory, including, for example, read-only memory (ROM), random access memory (RAM), flash memory, a magnetic storage media, an optical disc, erasable programmable read only memory (EPROM), programmable read only memory (PROM), etc. The memory 408 may be non-removable, removable, or a combination of both. The memory 408 may be implemented as a non-transitory computer readable medium storing one or more executable instructions such as, for example, logic, algorithms, code, etc.

As further discussed below, the instructions, logic, code, etc., stored in the memory 408 are represented by the various modules/engines as shown in FIG. 4. Alternatively, if implemented via hardware, the modules/engines shown in FIG. 4 associated with the memory 408 may include instructions and/or code to facilitate control and/or monitor the operation of such hardware components. In other words, the modules/engines as shown in FIG. 4 are provided for ease of explanation regarding the functional association between hardware and software components. Thus, the processor circuitry 402 may execute the instructions stored in these respective modules/engines in conjunction with one or more hardware components to perform the various functions as discussed herein.

Various aspects described herein may utilize one or more machine learning models for the system 100, 200 for privacy-enhanced data exchange. The term “model” as, for example, used herein may be understood as any kind of algorithm, which provides output data from input data (e.g., any kind of algorithm generating or calculating output data from input data). A machine learning model may be executed by a computing system to progressively improve performance of a specific task. In some aspects, parameters of a machine learning model may be adjusted during a training phase based on training data. A trained machine learning model may be used during an inference phase to make predictions or decisions based on input data. In some aspects, the trained machine learning model may be used to generate additional training data. An additional machine learning model may be adjusted during a second training phase based on the generated additional training data. A trained additional machine learning model may be used during an inference phase to make predictions or decisions based on input data.

The machine learning models described herein may take any suitable form or utilize any suitable technique (e.g., for training purposes). For example, any of the machine learning models may utilize supervised learning, semi-supervised learning, unsupervised learning, or reinforcement learning techniques.

In supervised learning, the model may be built using a training set of data including both the inputs and the corresponding desired outputs (illustratively, each input may be associated with a desired or expected output for that input). Each training instance may include one or more inputs and a desired output. Training may include iterating through training instances and using an objective function to teach the model to predict the output for new inputs (illustratively, for inputs not included in the training set). In semi-supervised learning, a portion of the inputs in the training set may be missing the respective desired outputs (e.g., one or more inputs may not be associated with any desired or expected output).

In unsupervised learning, the model may be built from a training set of data including only inputs and no desired outputs. The unsupervised model may be used to find structure in the data (e.g., grouping or clustering of data points), illustratively, by discovering patterns in the data. Techniques that may be implemented in an unsupervised learning model may include, e.g., self-organizing maps, nearest-neighbor mapping, k-means clustering, and singular value decomposition.

Reinforcement learning models may include positive or negative feedback to improve accuracy. A reinforcement learning model may attempt to maximize one or more objectives/rewards. Techniques that may be implemented in a reinforcement learning model may include, e.g., Q-learning, temporal difference (TD), and deep adversarial networks.

Various aspects described herein may utilize one or more classification models. In a classification model, the outputs may be restricted to a limited set of values (e.g., one or more classes). The classification model may output a class for an input set of one or more input values. An input set may include sensor data, such as image data, radar data, LIDAR (light detection and ranging) data and the like. A classification model as described herein may, for example, classify certain driving conditions and/or environmental conditions, such as weather conditions, road conditions, and the like. References herein to classification models may contemplate a model that implements, e.g., any one or more of the following techniques: linear classifiers (e.g., logistic regression or naive Bayes classifier), support vector machines, decision trees, boosted trees, random forest, neural networks, or nearest neighbor.

Various aspects described herein may utilize one or more regression models. A regression model may output a numerical value from a continuous range based on an input set of one or more values (illustratively, starting from or using an input set of one or more values). References herein to regression models may contemplate a model that implements, e.g., any one or more of the following techniques (or other suitable techniques): linear regression, decision trees, random forest, or neural networks.

A machine learning model described herein may be or may include a neural network. The neural network may be any kind of neural network, such as a convolutional neural network, an autoencoder network, a variational autoencoder network, a sparse autoencoder network, a recurrent neural network, a deconvolutional network, a generative adversarial network, a forward thinking neural network, a sum-product neural network, and the like. The neural network may include any number of layers. The training of the neural network (e.g., adapting the layers of the neural network) may use or may be based on any kind of training principle, such as backpropagation (e.g., using the backpropagation algorithm).

The techniques of this disclosure may also be described in the following examples.

Example 1. A system for privacy-enhanced sensor data exchange, comprising: a communication interface operable to receive sensor data related to surroundings of a sensor associated with an ego device; processor circuitry operable to: evaluate the sensor data for a privacy-sensitive attribute of the sensor data, wherein the sensor data is under privacy control of the ego device; filter the sensor data by decreasing a precision of a portion of the sensor data related to the privacy-sensitive attribute; and generate data packets based on the sensor data, formatted to enable discovery by an interested entity device.

Example 2. The system of example 1, wherein the privacy-sensitive attribute is based on a temporal aspect of the sensor data.

Example 3. The system of any of examples 1-2, wherein the privacy-sensitive attribute is based on a geographic aspect of the sensor data.

Example 4. The system of any of examples 1-3, wherein the processor circuitry is further operable to: restrict from discovery or access by the interested entity device a portion of the sensor data related to a predefined geographic region or a temporal period.

Example 5. The system of any of examples 1-4, wherein the processor circuitry is further operable to: poll a data broker system for a sensor data request by the interested entity device.

Example 6. The system of example 5, wherein the processor circuitry is further operable to: evaluate the sensor data request; and push the data packets to the interested entity device, after approving the sensor data request.

Example 7. The system of example 6, wherein in response to a request by the interested entity device, the processor circuitry is further operable to: push the data packets to the interested entity device directly, bypassing the data broker system.

Example 8. The system of any of examples 1-7, wherein the ego device is an autonomous device or a wireless communication device.

Example 9. The system of any of examples 1-8, wherein the processor circuitry is further operable to: push the data packets, via an onion network, via a communication system operable to encrypt data in layers to maintain anonymity, to a cloud-based storage, a data broker system, or the interested entity device.

Example 10. The system of any of examples 1-9, wherein the processor circuitry is further operable to: generate false data packets, synthetic data packets, or modified data packets to obfuscate the privacy-sensitive attribute of the sensor data.

Example 11. The system of any of examples 1-10, wherein the processor circuitry is further operable to: generate for the interested entity device a sensor data access denial notification.

Example 12. The system of any of examples 1-11, wherein the processor circuitry is further operable to: encrypt a portion of the sensor data to be not discoverable by the interested entity device or a data broker system.

Example 13. The system of any of examples 1-12, wherein the ego device is operable to receive compensation in exchange to push the data packets to the interested entity device.

Example 14. A component of a system, comprising: an interface operable to receive sensor data related to surroundings of a sensor associated with an ego device; processor circuitry; and a non-transitory computer-readable storage medium including instructions that, when executed by the processor circuitry, cause the processor circuitry to: evaluate the sensor data for a privacy-sensitive attribute of the sensor data, wherein the sensor data is under privacy control of the ego device; filter the sensor data by decreasing a precision of a portion of the sensor data related to the privacy-sensitive attribute; and generate data packets based on the sensor data, formatted to enable discovery by an interested entity device.

Example 15. The component of example 14, wherein the privacy-sensitive attribute is based on a temporal aspect of the sensor data.

Example 16. The component of any of examples 14-15, wherein the privacy-sensitive attribute is based on a geographic aspect of the sensor data.

Example 17. The component of any of examples 14-16, wherein the instructions cause the processor circuitry to: restrict from discovery or access by the interested entity device a portion of the sensor data related to a predefined geographic region or a temporal period.

Example 18. The component of any of examples 14-17, wherein the instructions cause the processor circuitry to: poll a data broker system for a sensor data request by the interested entity device.

Example 19. The component of example 18, wherein the instructions cause the processor circuitry to: evaluate the sensor data request; and push the data packets to the interested entity device, after approval of the sensor data request.

Example 20. The component of example 19, wherein in response to a request by the interested entity device, wherein the instructions cause the processor circuitry to: push the data packets to the interested entity device directly, bypassing the data broker system.

While the foregoing has been described in conjunction with exemplary aspect, it is understood that the term “exemplary” is merely meant as an example, rather than the best or optimal. Accordingly, the disclosure is intended to cover alternatives, modifications and equivalents, which may be included within the scope of the disclosure.

Although specific aspects have been illustrated and described herein, it will be appreciated by those of ordinary skill in the art that a variety of alternate and/or equivalent implementations may be substituted for the specific aspects shown and described without departing from the scope of the present application. This application is intended to cover any adaptations or variations of the specific aspects discussed herein.

1. A system for privacy-enhanced sensor data exchange, comprising:
a communication interface operable to receive sensor data related to surroundings of a sensor associated with an ego device;
processor circuitry operable to:
evaluate the sensor data for a privacy-sensitive attribute of the sensor data, wherein the sensor data is under privacy control of the ego device;
filter the sensor data by decreasing a precision of a portion of the sensor data related to the privacy-sensitive attribute; and
generate data packets based on the sensor data, formatted to enable discovery by an interested entity device.

2. The system of claim 1, wherein the privacy-sensitive attribute is based on a temporal aspect of the sensor data.

3. The system of claim 1, wherein the privacy-sensitive attribute is based on a geographic aspect of the sensor data.

4. The system of claim 1, wherein the processor circuitry is further operable to:
restrict from discovery or access by the interested entity device a portion of the sensor data related to a predefined geographic region or a temporal period.

5. The system of claim 1, wherein the processor circuitry is further operable to:
poll a data broker system for a sensor data request by the interested entity device.

6. The system of claim 5, wherein the processor circuitry is further operable to:
evaluate the sensor data request; and
push the data packets to the interested entity device, after approving the sensor data request.

7. The system of claim 6, wherein in response to a request by the interested entity device, the processor circuitry is further operable to:
push the data packets to the interested entity device directly, bypassing the data broker system.

8. The system of claim 1, wherein the ego device is an autonomous device or a wireless communication device.

9. The system of claim 1, wherein the processor circuitry is further operable to:
push the data packets, via an onion network, via a communication system operable to encrypt data in layers to maintain anonymity, to a cloud-based storage, a data broker system, or the interested entity device.

10. The system of claim 1, wherein the processor circuitry is further operable to:
generate false data packets, synthetic data packets, or modified data packets to obfuscate the privacy-sensitive attribute of the sensor data.

11. The system of claim 1, wherein the processor circuitry is further operable to:
generate for the interested entity device a sensor data access denial notification.

12. The system of claim 1, wherein the processor circuitry is further operable to:
encrypt a portion of the sensor data to be not discoverable by the interested entity device or a data broker system.

13. The system of claim 1, wherein the ego device is operable to receive compensation in exchange to push the data packets to the interested entity device.

14. A component of a system, comprising:
an interface operable to receive sensor data related to surroundings of a sensor associated with an ego device;
processor circuitry; and
a non-transitory computer-readable storage medium including instructions that, when executed by the processor circuitry, cause the processor circuitry to:
evaluate the sensor data for a privacy-sensitive attribute of the sensor data, wherein the sensor data is under privacy control of the ego device;
filter the sensor data by decreasing a precision of a portion of the sensor data related to the privacy-sensitive attribute; and
generate data packets based on the sensor data, formatted to enable discovery by an interested entity device.

15. The component of claim 14, wherein the privacy-sensitive attribute is based on a temporal aspect of the sensor data.

16. The component of claim 14, wherein the privacy-sensitive attribute is based on a geographic aspect of the sensor data.

17. The component of claim 14, wherein the instructions cause the processor circuitry to:
restrict from discovery or access by the interested entity device a portion of the sensor data related to a predefined geographic region or a temporal period.

18. The component of claim 14, wherein the instructions cause the processor circuitry to:
poll a data broker system for a sensor data request by the interested entity device.

19. The component of claim 18, wherein the instructions cause the processor circuitry to:
evaluate the sensor data request; and
push the data packets to the interested entity device, after approval of the sensor data request.

20. The component of claim 19, wherein in response to a request by the interested entity device, wherein the instructions cause the processor circuitry to:
push the data packets to the interested entity device directly, bypassing the data broker system.
